(19) United States
(12) Patent Application Publication
(10) Pub. No.: US 2006/0180184 A1
(43) Pub. Date: Aug. 17, 2006

(54) Sump of dishwasher

(75) Inventor: Hae Deog Jeong, Changwon-si (KR)

Correspondence Address: MCKENNA LONG & ALDRIDGE LLP, 1900 K STREET, NW, WASHINGTON, DC, 20006, US

(73) Assignee: LG ELECTRONICS, INC., Youngsungpo-gu (KR)

(21) Appl. No.: 11/337,798

(22) Filed: Jan. 24, 2006

(30) Foreign Application Priority Data
Jan. 25, 2005 (KR) 10-2005-006619

(51) Int. Cl. B08B 3/00

(52) U.S. Cl. 134/56 D

(57) ABSTRACT

A sump of a dishwasher is provided. The dishwasher sump includes a case, a drain pump formed on the sump case, and a check valve that maintains pressure inside the drain pump at a predetermined pressure.

### BACKGROUND OF THE INVENTION

1. Field of the Invention

The present invention relates to a dishwasher, and more particularly, to a sump of a dishwasher.

2. Description of the Related Art

A dishwasher is a home appliance that sprays high-pressure wash liquid through spray nozzles to wash and remove food residue left on surfaces of dishes. Specifically, a dishwasher includes a tub forming a wash compartment, and a sump installed at the bottom of the tub for storing wash liquid. Installed inside the sump is a wash pump that pumps wash liquid to the spray nozzles. The wash liquid pumped to the spray nozzles is discharged under high pressure through spray holes at the ends of the nozzles. The high-pressure wash liquid spray collides with the surfaces of dishes, so that food residue and other impurities on the dishes fall to the floor of the tub.

A dishwasher according to the related art has a drain pump attached at a side of the sump. Wash liquid that has been contaminated during a wash cycle flows to the drain pump and is discharged through it in a drain cycle.

However, in the structure of a dishwasher sump according to the related art, when a filter that is installed inside the sump becomes clogged with food particles and other impurities, the pressure in the drain pump increases. When the pressure in the drain pump surpasses a certain level, wash liquid that has accumulated inside the drain pump automatically leaks and drains from the drain pump during a wash cycle. This results in a decrease in the amount of wash liquid stored in the sump during a wash cycle and a resultant decrease in the pumping pressure of the wash pump. When the pumping pressure of the wash pump decreases, the pressure of wash liquid sprayed from the spray nozzles decreases, so that dishes cannot be completely washed and removed of impurities on them.

### SUMMARY OF THE INVENTION

Accordingly, the present invention is directed to a dishwasher that substantially obviates one or more problems due to limitations and disadvantages of the related art.

An object of the present invention is to provide a dishwasher sump that prevents the occurrence of automatic drainage even when pressure inside a drain pump exceeds a normal level.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a sump of a dishwasher including: a sump case; a drain pump formed on the sump case; and a check valve for maintaining a pressure inside the drain pump below a predetermined pressure.

In another aspect of the present invention, there is provided a sump of a dishwasher including: a sump case; a drain pump formed on the pump case; and a check valve forming a slit for opening and allowing wash liquid to flow from the drain pump to the sump case, when a pressure inside the drain pump reaches a predetermined pressure.

In a further aspect of the present invention, there is provided a sump of a dishwasher including: a sump case; a drain pump formed on the pump case; and a check valve including a bendable connecting portion for allowing wash liquid to flow from the sump case to the drain pump.

The sump of a dishwasher according to the present invention is capable of preventing automatic drainage of wash liquid, even when the pressure inside a drain pump exceeds normal levels during a wash cycle. By preventing automatic drainage of wash liquid, there is no decrease in the pumping pressure of a wash pump during a wash cycle, so that a reduction of the spraying pressure of wash liquid through spray nozzles can be prevented.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view of a dishwasher having a sump according to the present invention;

FIG. 2 is a perspective view of a sump according to the present invention;

FIGS. 3 is a sectional view of the sump in FIG. 2 taken along lines I-I′;

FIG. 4 is a side view of a check valve according to the present invention; and

FIG. 5 is a perspective view of the check valve in FIG. 4.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

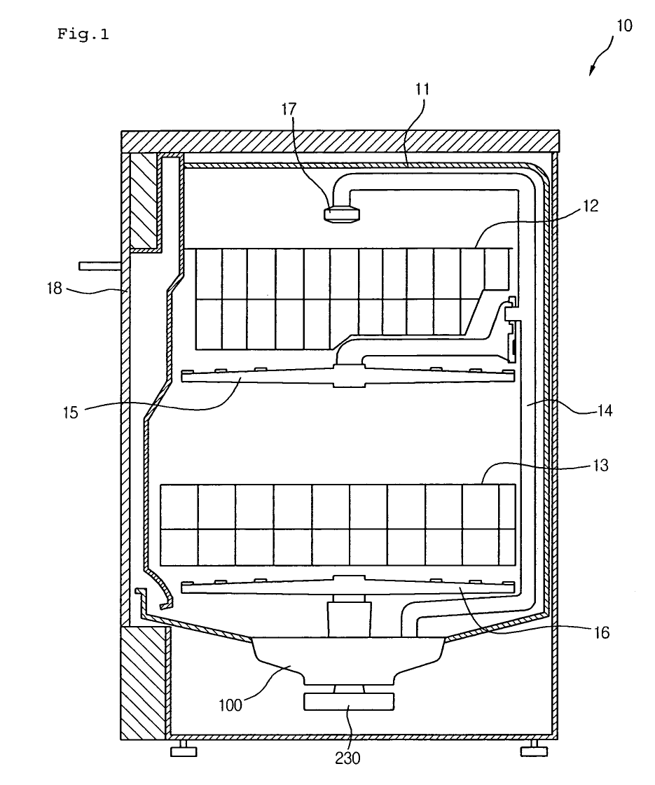

FIG. 1 is a sectional view of a dishwasher having a sump according to the present invention.

Referring to FIG. 1, a dishwasher 10 according to the present invention includes a tub 11, a door 18, a sump 100, a wash motor 230, a water guide 14, a lower spray arm 16, an upper spray arm 15, a top nozzle 17, an upper rack 12, and a lower rack 13.

The tub 11 forms a wash compartment within. The door 18 is formed at the front of the tub 11 for opening and closing the wash compartment. The sump 100 is formed at the central bottom portion of the tub 11 for storing wash liquid inside.

The wash motor 230 is attached at the bottom of the sump 100 for driving a wash pump (not shown) installed inside the sump 100. The water guide 14 forms a passage for wash liquid pumped by the wash pump.

The lower spray arm 16 is coupled above the sump 100 for spraying wash liquid in an upward and/or downward direction inside the wash compartment. The upper spray arm 15 is attached to an upper portion of the water guide 14 and extends perpendicularly therefrom to the center of the wash compartment. The stop nozzle 17 is formed at the ceiling of the tub 11 for spraying wash liquid in a downward direction.

The upper rack 12 is located above the upper spray arm 15 to wash dishes with the upper spray arm 15. The lower rack 13 is located above the lower spray arm 16 to wash dishes with the lower spray arm 16.

The operation of the dishwasher 10 according to the present invention will now be described.

First a user opens the door 18 of the dishwasher 10, and pulls the upper rack 12 and/or lower rack 13 out from the wash compartment. Then, dishes are loaded onto the dish racks 12 and 13, the door 18 is closed, and power is turned on operate the dishwasher 10.

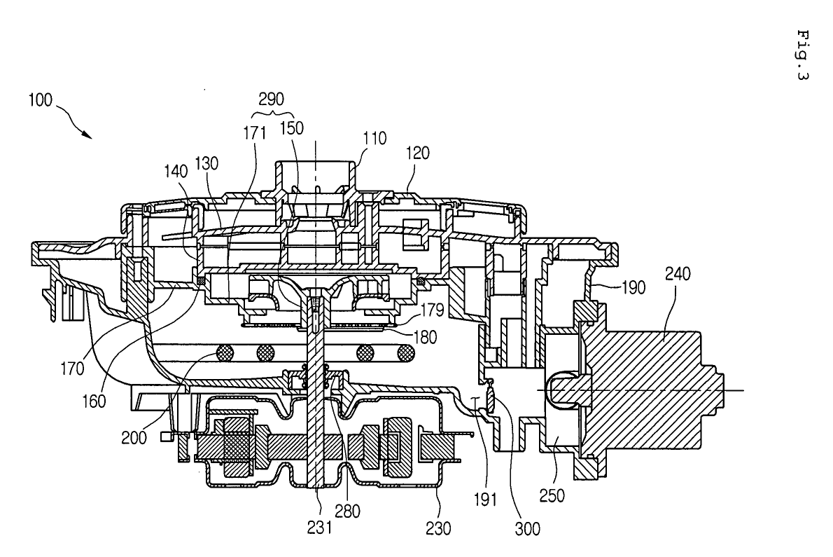

When power is applied to the dishwasher 10 and a wash cycle is begun, wash liquid is supplied to the inside of the sump 100 from a water supply. After a certain amount of wash liquid enters the sump 100, the wash motor 230 operates. An impeller (150 in FIG. 3), provided inside the wash pump and connected to the shaft of the wash motor 230, rotates to pump wash liquid to the lower spray arm 16 and the water guide 14.

The wash liquid pumped to the water guide 14 flows to the top nozzle 17 and the upper spray arm 15 to be ultimately sprayed therefrom into the wash compartment. The sprayed wash liquid washes the dishes loaded on the racks 12 and 13.

Here, the top nozzle 17 sprays wash liquid vertically downward, and the upper spray arm 15 sprays wash liquid vertically upward, to wash dishes stored in the upper rack 12.

The lower spray arm 16 sprays wash liquid vertically upward to wash dishes stored in the lower rack 13. The upper spray arm 15 may have spray holes formed at the bottom thereof to spray wash liquid in both upward and downward directions in order to wash the top portions of dishes stores in the lower rack 13.

Impurities that are released during the wash cycle are filtered by a filter installed in the sump 100. The filtered wash liquid is discharged to the outside of the dishwasher 10 by a drain pump (250 in FIG. 3) in a drain cycle, following the wash cycle.

When the wash liquid is discharged to the outside, fresh wash liquid enters into the sump 100 through an intake, whereupon a cycle similar to the wash cycle is performed to spray wash liquid through the spray arms 15 and 16. The thus sprayed fresh wash liquid rinses the dishes in a rinse cycle. When the rinse cycle is finished, a drying cycle is performed to complete the entire wash course.

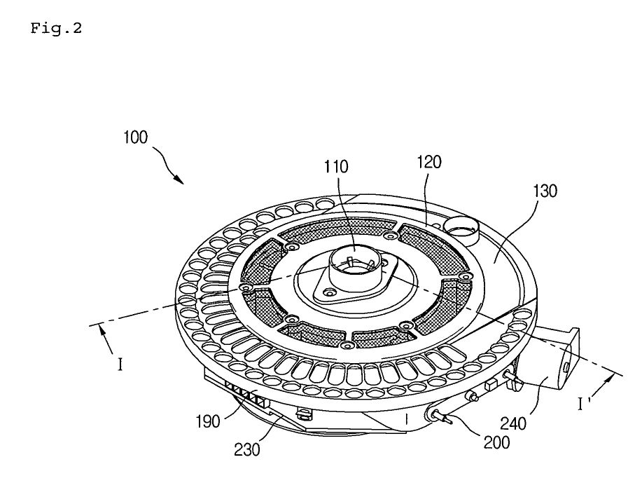

FIG. 2 is a perspective view of a sump according to the present invention, and FIGS. 3 is a sectional view of the sump in FIG. 2 taken along lines I-I′.

Referring to FIGS. 2 and 3, the sump 100 according to the present invention includes a sump case 190 that is the lower portion of the sump 100 for storing wash liquid. A sump cover 130 covers the upper portion of the sump case 190. A self-cleaning filter 120 is stepped and mounted a predetermined height upward on the top portion of the sump cover 130. A lower spray arm holder 110 is mounted at the central portion of the self-cleaning filter 120 and connected to the lower spray arm 16.

A wash motor 230 is installed below the sump case 190 for generating rotational force. The drain pump 250 and a drain motor 240 are mounted to the side of the sump case 190 for discharging wash liquid to the outside.

The sump 100 also includes a heater 200 installed on the inner floor of the sump case 190 for heating wash liquid. A disposer 180 is connected to a motor shaft 231 of the wash motor 230 to rotate integrally with the motor shaft 231 and grind food particles. A pump lower unit 170 mounted above the sump case 190. The pump lower unit 170 has a soil chamber formed thereon for collecting food particles.

A guide passage 140 is formed between the sump cover 130 and the pump lower unit 170. A wash pump 290 is formed between the pump lower unit 170 and the guide passage 140 for pumping wash liquid. A screen filter 179 is installed between the pump lower unit 170 and the disposer 180 for preventing food particles ground by the disposer 180 from entering the wash pump 290. In further detail, the screen filter 179 has a plurality of small holes formed thereon to filter food particles, and is attached to the bottom surface of the pump lower unit 170.

The wash pump 290 includes: an impeller 150 mounted to the central portion of the pump lower unit 170, the impeller 150 connected to and rotating with the motor shaft 231; and a pump case 171 in which wash liquid rises by means of the impeller 150 and rotates.

The guide passage 140 has a passage formed therein for guiding wash liquid pumped by the wash pump 290 at its upper portion to the upper spray arm or the lower spray arm.

The sump 100 includes a vario valve (not shown) installed at a side of the sump case 190 that alternately regulates the flow of wash liquid pumped by the wash pump 290 to the upper spray arm and the lower spray arm. A turbidity sensor (not shown) is installed proximally to the vario valve, and senses the contamination level of wash liquid collected in the sump 100 during the wash course. A pump seal 160 inserts into a groove formed in the top surface of the pump lower unit 170, preventing wash liquid from leaking between the edges of the wash pump 290 and the vario valve.

A check valve 300 is installed inside the sump case 190, or more specifically, near the entrance to the drain pump 250. The check valve 300 prevents wash liquid that enters the drain pump 250 from reentering the inside of the sump case 190.

The operation of the sump 100 according to the present invention will now be described.

First, wash liquid enters the inside of the sump case 190 through a water supply device when a wash course is begun. Then, the wash motor 230 operates to rotate the impeller 150. When the impeller 150 rotates, wash liquid enters the pump case 171. The wash liquid that enters the pump case flows toward the vario valve. The wash liquid that flows to the vario valve flows to the water guide 14 formed at the top of the guide passage 140 or the lower spray arm holder 110. The wash liquid that flows to the water guide 14 or the lower spray arm holder 110 is sprayed into the tub 11 through the upper spray arm 15 and the top nozzle 17 or the lower spray arm 16. The sprayed pressure of the wash liquid washes impurities on dishes. The wash liquid sprayed inside the tub 11 falls to the floor of the tub 11. The wash liquid that falls flows back into the sump case 190.

A portion of the wash liquid flowing from the wash pump 290 to the vario valve branches towards the turbidity sensor. The wash liquid whose contamination level is measured as it passes the turbidity sensor flows to the drain pump 250, and the wash liquid collected at the drain pump 250 is discharged to the outside of the dishwasher by the operation of the drain motor 240.

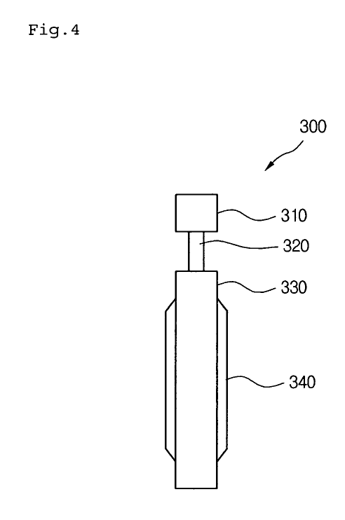

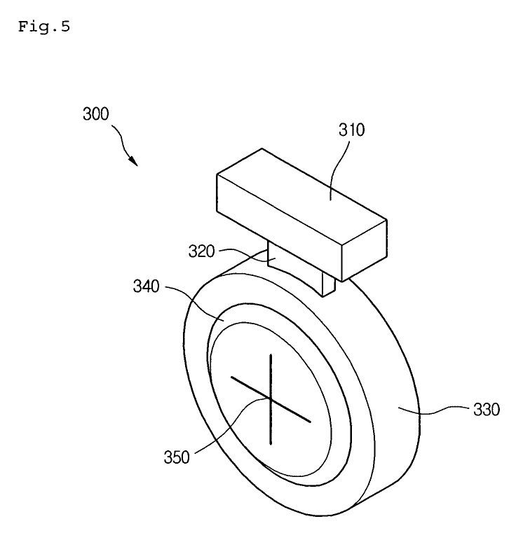

FIG. 4 is a side view of a check valve according to the present invention, and FIG. 5 is a perspective view of the check valve in FIG. 4.

Referring to FIGS. 4 and 5, a check valve 300 according to the present invention includes a cylindrical valve body 330 of a predetermined thickness. A protruding portion 340 protrudes from both the front and rear of the valve body 330. A hinge 310 is formed on top of the valve body 330 to fasten the valve body to the sump case 190. A connecting portion 320 is formed between the hinge 310 and the valve body 330 to connect the two.

The protruding portion 340 has a slit 350 formed thereon. The slit 350 opens when the pressure inside the drain pump 250 exceeds a predetermined pressure. Then, the wash liquid within the drain pump can flow into the sump case 190. In further detail, the slit 350 is formed in plurality to mutually intersect one another. The slit 350 is cut through the valve body 330. Thus, when the pressure inside the drain pump 250 located behind the check valve 300 is excessive, the slits 350 open. A portion of the wash liquid inside the wash pump 250 flows back into the sump case through the open slits, reducing the pressure in the drain pump 250.

The protruding portion 340 is located at the front of the check valve 300 to open and close the connecting hole (191 in FIG. 3) connecting the sump case 190 with the drain pump 250. In more detail, the outer diameter of the protruding portion 340 and the inner diameter of the connecting hole 191 are formed to be equal so that the protruding portion 340 is pressed closely against a region of the connecting hole 191. Accordingly, when the check valve 300 is closed, wash liquid leaking through the connecting hole 191 is prevented. Here, the protruding portion 340 may be formed only at the front of the check valve 300, or at both the front and rear of the check valve 300.

The connecting portion 320 has a degree of elasticity, and can bend. For this end, the connecting portion 320 may be formed of a rubber material. As a result, the connecting portion 320 can bend during a draining cycle to open the connecting hole 191. Due to the opened connecting hole, the wash liquid inside the sump case 190 can flow into the drain pump 250.

The slit 350 has a thickness that allows it to withstand a certain amount of pressure before parting, and may be made of a material that can withstand this predetermined pressure before parting. For example, the slit 350 may be made of a rubber material. For the sake of manufacturing ease, the check valve 300 may be made entirely of a rubber material.

The above-structured sump of a dishwasher prevents automatic drainage of wash liquid during a wash cycle when the pressure inside a drain pump increases.

Consequently, by preventing automatic drainage of wash liquid, the pressure generated by the wash pump during a wash cycle does not diminish, and a reduction of spray pressure of wash liquid through the spray nozzles can be prevented.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A sump of a dishwasher comprising:
a sump case;
a drain pump formed on the sump case; and
a check valve for maintaining a pressure inside the drain pump below a predetermined pressure.

2. The sump according to claim 1, wherein the check valve includes a slit cut a predetermined length therein, the slit opening to allow wash liquid inside the drain pump to flow to the sump case, when the pressure inside the drain pump reaches the predetermined pressure.

3. The sump according to claim 2, wherein the slit is formed in plurality, and the plurality of slits are mutually intersected one another.

4. The sump according to claim 1, wherein the check valve is installed at an entrance of the drain pump.

5. The sump according to claim 1, wherein a portion of the sump case contacting the check valve is sealed against the check valve.

6. The sump according to claim 5, wherein a portion of the check valve contacting the sump case protrudes a predetermined distance.

7. The sump according to claim 1, wherein the check valve is made of a rubber material.

8. The sump according to claim 1, wherein the check valve includes a bendable connecting portion formed thereon for allowing wash liquid to flow from the sump case to the drain pump.

9. A sump of a dishwasher comprising:
a sump case;
a drain pump formed on the pump case; and
a check valve forming a slit for opening and allowing wash liquid to flow from the drain pump to the sump case, when a pressure inside the drain pump reaches a predetermined pressure.

10. The sump according to claim 9, wherein the slit is formed in plurality, and the plurality of slits are mutually intersected one another.

11. The sump according to claim 9, wherein the check valve is installed at an entrance of the drain pump.

12. The sump according to claim 9, wherein a portion of the sump case contacting the check valve is sealed against the check valve.

13. The sump according to claim 12, wherein a portion of the check valve contacting the sump case protrudes a predetermined distance.

14. The sump according to claim 9, wherein the check valve is made of a rubber material.

15. The sump according to claim 9, wherein the check valve includes a bendable connecting portion formed thereon for allowing wash liquid to flow from the sump case to the drain pump.

16. A sump of a dishwasher comprising:
a sump case;
a drain pump formed on the pump case; and
a check valve including a bendable connecting portion for allowing wash liquid to flow from the sump case to the drain pump.

17. The sump according to claim 16, wherein the connecting portion is made of a rubber material.

18. The sump according to claim 16, wherein the check valve further includes a slit for opening and allowing wash liquid to flow from the drain pump to the sump case, when a pressure inside the drain pump reaches a predetermined pressure.

19. The sump according to claim 18, wherein the slit is provided in plurality, and the plurality of slits are mutually intersected one another.

20. The sump according to claim 18, wherein a portion of the sump case contacting the check valve is sealed against the check valve.
